(19) United States
(12) Patent Application Publication
(10) Pub. No.: US 2022/0265512 A1
(43) Pub. Date: Aug. 25, 2022

(54) Chakra Aligning Wellness Wear

(71) Applicant: Jessica Lopera, Glen Cove, NY (US)

(72) Inventor: Jessica Lopera, Glen Cove, NY (US)

(21) Appl. No.: 17/536,243

(22) Filed: Nov. 29, 2021

Related U.S. Application Data
(60) Provisional application No. 63/152,183, filed on Feb. 22, 2021.

(51) Int. Cl. A61H 99/00; A44C 15/00

(52) U.S. Cl. CPC A61H 99/00; A44C 15/00; A61H 2201/165

(57) ABSTRACT

The present invention provides a wearable wellness device that comprises a plurality of sections. The sections include a bracket, side members, a first line member, a second line member; and a plurality of stones attached to the bracket. The plurality of sections are connected by the first line member and the second line member. Some sections can be eliminated in the wearable wellness of the present invention the arrangement of the sections can be altered.

### FIELD OF THE INVENTION

The present invention generally relates to lithotherapy. More specifically, the present invention relates to a therapeutic method using the harmonizing effects of gemstones.

### BACKGROUND OF THE INVENTION

A therapeutic method using the harmonizing effects of gemstones is in demand. Lithotherapy is an alternative system of medicine that uses the energy and colors of stones to harmonize the body. Lithotherapy is a care method using stones and minerals that have vibrations and qualities that can help remove physical, mental, and emotional stress.

The use of precious stones for human therapy has been known since the time of ancient China, ancient Egypt, and the Incan and Mayan civilizations. Generally, stones are used on various places on the body where a person is experiencing such issues as pain or tension, inducing physical and mental harmonization.

Although no scientific studies have yet confirmed the exact nature of precious stones' harmonization effects, many people find the practice beneficial. It can be assumed that the effect is related to the different colorations of precious stones because different stone colors absorb certain wavelengths of light and colored stones can transmit some light energy.

The principles of lithotherapy for personal and practitioner usage involve aligning stones with the chakras from the back. Wearable pieces that allow new, additional methods (according to the respective therapies/studies) have been limited to placing the stones along the person/patient's body. The conventional methods cannot complete the full therapeutic circuit because the patient must lie on their back in order to balance the stone (e.g., on the 6th and 7th chakras).

Generally, conventional pieces are impractical because they require applying the stones to rest on the back or abdomen while the user is lying down, requiring the individual to lie still. In addition, positioning a stone can be complicated by its shape and the shape of the human body. Thus, there is a need to develop a device to solve these problems.

The present invention is intended to address problems associated with and/or otherwise improve on conventional devices through an innovative wearable device designed to provide a convenient, effective means to wear therapeutic stones while incorporating other problem-solving features.

### SUMMARY

In accordance with the present invention, a wearable wellness device is provided. The wearable wellness device comprises a plurality of sections. The sections include a bracket, side members, a first line member, a second line member; and a plurality of stones attached to the bracket. The plurality of sections are connected by the first line member and the second line member.

One or more stones can be attached to the present invention. The stones can include lolite, selenite, blue lace agate, tiger's eye, citrine, rose quartz, carnelian, black tourmaline, malachite, or amethyst.

In one embodiment, the present invention can include seven different sections connected together. The first section can include one black tourmaline stone, the second section can include two carnelian stones, the third section can include a combination of citrine and tiger's eye stones, the fourth section can include a mix of four malachite or rose quartz stones, the fifth section can includes five blue lace agate stones, the two sixth sections can include selenite (each having three stones), and the seventh section can include seven Iolite stones (possibly mixed with amethyst).

In some embodiments, some sections can be eliminated in the wearable wellness of the present invention and the arrangement of the sections can be altered.

The present invention allows the user to conveniently wear the wearable wellness device by putting the present invention around the user's head, wrapping the desired sections around the head. The user can make a loop by using the clasp provided at the end of the last section and adjusting the size of the loop so that the present invention can be worn on the user's head, aligning the rest of the sections with the center of the user's back.

### BRIEF DESCRIPTION OF THE DRAWINGS

FIG. 1 is an illustration of one embodiment of the present invention.

FIG. 2 is an illustration of one embodiment of a section of the present invention.

FIG. 3 is an illustration of one embodiment showing a section two and a section three of the present invention connected together.

FIG. 4 is an illustration of alternative embodiment showing the section two and the section three of the present invention connected together.

FIG. 5 is an illustration of one embodiment of the sections of the present invention worn on a user.

### DETAIL DESCRIPTIONS OF THE INVENTION

All illustrations of the drawings are for the purpose of describing selected versions of the present invention and are not intended to limit the scope of the present invention.

The present invention provides a wearable wellness device that will allow alternative lithotherapy techniques with grounding possibilities and essential daylong wear.

This wearable wellness device will help practitioners, osteopaths, masseuses, and reiki masters navigate deeper into their respective fields with the understanding that back chakra work represents the ideal.

The present invention bypasses the requirement of having the person/patient lie on their back. Specifically, the present invention offers the ability to hit each lithotherapy zone, including the 6th and 7th chakras, whether standing or assuming the true form of lying supine on one's stomach.

The present invention can also be used with various delicate, ornate, decorative pieces with interchangeable stones (add-ons) that serve people primarily working in fields involving lithotherapy. The present invention can make the execution of their study easier while also expanding the possibilities, offering a tool to create and explore new territory in their fields of ancient study with the assistance of modern convenience. The secondary use of the present invention can be for individuals who have a cultural understanding or personal interest in the benefits of lithotherapy while being completely self-regulated.

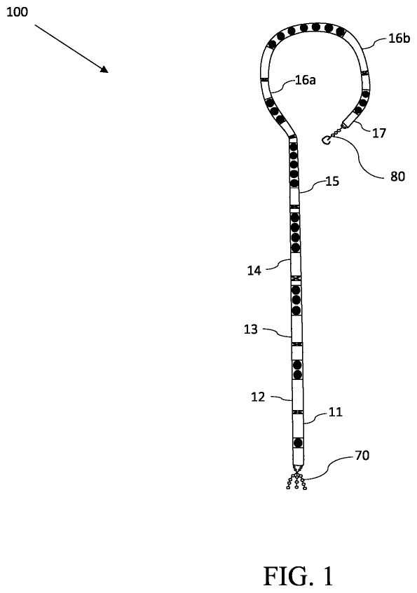

As shown in FIG. 1, the present invention provides a wearable wellness device 100 comprising a plurality of sections 11,12,13,14,15,16a,16b,17.

The sections 11,12,13,14,15,16a,16b, 17 can be joined together to form the present invention's wearable wellness device.

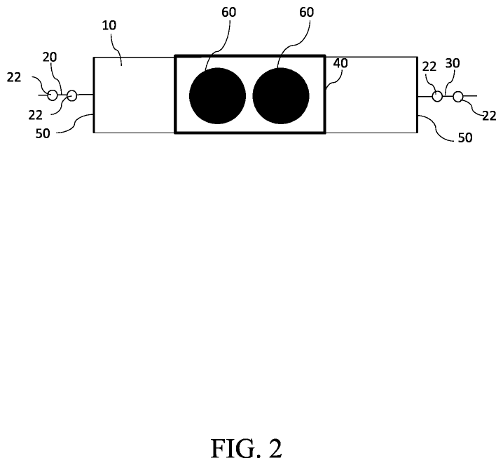

The sections 11,12,13,14,15,16a,16b, 17 as shown in FIG. 2, may include a rectangular panel 10, a first line member 20, a second line member 30, a bracket 40, side members 50, and a plurality of stones 60. Each first and second line member 20, 30 can be in any suitable size and made of any suitable material, including metal.

The side members 50 can be attached to opposite ends of the rectangular panel 10. The first line member 20 and the second line member 30 can be attached to the side members 50. The bracket 40 can be positioned on the rectangular panel 10. The plurality of stones 60 can be placed in the bracket 40.

Each end of the first and second line members 20, 30 can be attached to one end of the side members 50, which can function as a stability bar for the sections 11,12,13,14,15,16a,16b, 17.

For naming convention purposes, for an embodiment that includes multiple sections with different number of stones, a first section 11 can be the section with one stone, a second section 12 can be the section with two stones, a third section 13 can be the section with three stones, a fourth section 14 can be the section with four stones, a fifth section 15 can be the section with five stones, two sixth sections 16 can be the section with six stones, and a seventh section 17 can be the section with seven stones.

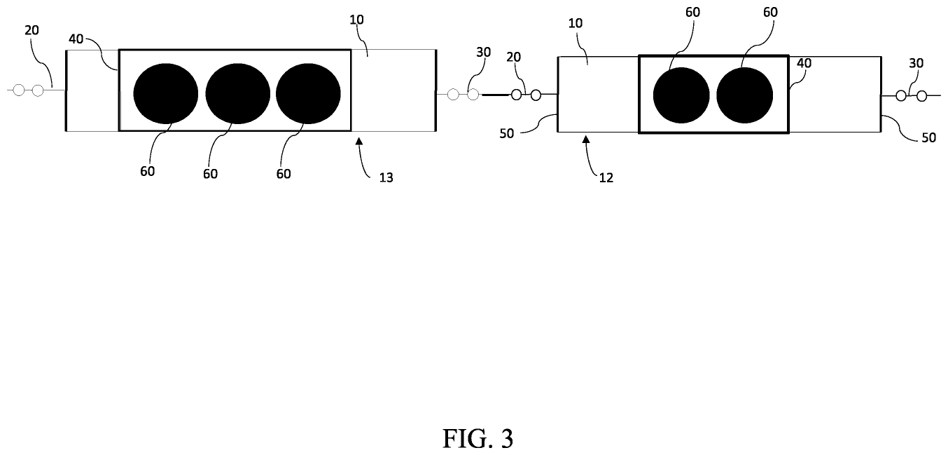

In some embodiments, the first and second line members 20, 30 can be attached to the side members 50 and the first or second line members 20, 30 can be used to connect each sections 11,12,13,14,15,16a,16b, 17 as shown in FIG. 3. For example, the second line member of the third section 13 and the first line member 20 of the second section 12 can be connected to connect the third section 13 and the second section 12.

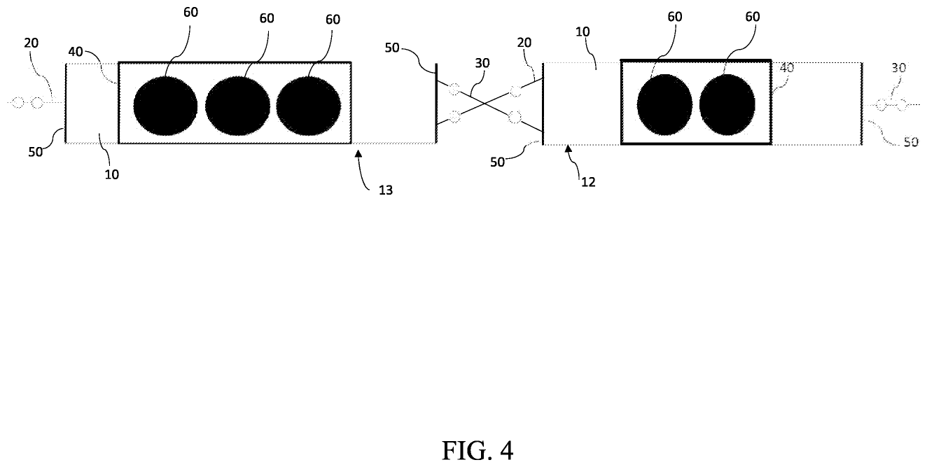

Alternatively, as shown in FIG. 4, the second line member 30 of the third section 13 can be directly attached to the side member 50 of the second section 12 and the first line member 20 of the second section 12 can also be directly attached to the side member 50 of the third section 13 to connect the third section 13 and the second section 12.

The bracket 40 can be secured to the sections 11,12,13,14,15,16a,16b,17 so that one side of the bracket 40 is attached facing the first line member 20 and the other side of the bracket is attached facing the second line member 30. In some embodiments, the bracket 40 can be positioned substantially in the middle or positioned at a location between one end and the middle of the sections 11,12,13,14,15,16a,16b,17.

One or more stones 60 can be attached to the bracket 40. The stones 60 can include any suitable stones for therapy, such as lolite, selenite, blue lace agate, tiger's eye, citrine, rose quartz, carnelian, black tourmaline, malachite, or amethyst. In this embodiment, the first and second line members 20, 30 may include a plurality of balls 22 or ball-like structures attached along the length with a suitable space in between.

A plurality of sections 11,12,13,14,15,16a,16b, 17 can be connected to each other by connecting the side members 50 by a clasp or any other similar fastener known in the art.

In some embodiments, the wearable wellness device 100 of the present invention can include multiple sections 11,12,13,14,15,16a,16b,17 with each section 11,12,13,14,15,16a,16b, and 17 having a different number of stones 60. For example, each section 11,12,13,14,15,16a,16b, 17 may include an increasing number of stones 60, starting from one so that the seventh section 17 includes seven stones 60. Each section 11,12,13,14,15,16a,16b,17 can be named after the number of stones the section includes. For example, section two 12 can include two stones 60 and section three 13 can include three stones 60.

In one embodiment, the first section (having one stone) 11 can include one or more add-ons 70 attached on the free end and not connected to the other sections 12,13,14,15,16a,16b,17. The add-ons 70 can include a chain with pink danburite, danburite, labradorite, or any assorted decorative dangle attachments made of stone (e.g., dangle combo of garnets, quartz, and onyx attachments). In some embodiments, the add-ons 70 can be a single dangle attachment.

The last section 17 (having multiple stones) can include a chain 80 with a clasp or similar fastener attached on one free end to allow the clasp or the fastener provided at the end to be adjustable. For example, the chain 80 with a clasp on one end can be attached to the free end of the last section 17, and the user can attach the chain 80 with the clasp to any desired section 11,12,13,14,15,16a,16b, 17 to make a closed loop on the side of the wearable wellness device of the present invention. The user can also adjust the size of the loop by moving the position of the clasp attached to the any portion of the present invention.

In a preferred embodiment, the wearable wellness device 100 of the present invention includes eight sections 11,12,13,14,15,16a,16b,17 with two sixth sections (a first sixth section 16a and a second sixth section 16b) attached together. In this preferred embodiment, the first section 11 includes one black tourmaline stone, the second section 12 includes two carnelian stones, the third section 13 includes a combination of citrine and tiger's eye stones (two each), the fourth section 14 includes a mix of four malachite or rose quartz stones, the fifth section 15 includes five blue lace agate stones, the two sixth sections 16a, 16b include selenite (each having three stones), and the seventh section 17 includes seven Iolite stones (possibly mixed with amethyst).

In some embodiments, the sections' arrangement can be as follows: first section 11, second section 12, third section 13, fourth section 14, fifth section 15, sixth section 16a, seventh section 17, and another sixth section 16b.

In some embodiments, if the user desires, some sections 11,12,13,14,15,16a,16b, 17 can be eliminated. For example, the user can disconnect the second section 12 and connect the first section 11 directly to the third section 13.

In some other embodiments, the arrangement of the stones 60 in each section 11,12,13,14,15,16a,16b,17 can be such that bloodstone or black obsidian is included in the first section 11, with golden tiger's eye in the second section 12, fire opal or amber in the third section 13, rhodonite or green agate or green opal in the fourth section 14, aquamarine in the fifth section 15, lapis lazuli in the sixth section 16, and amethyst in the seventh section 17.

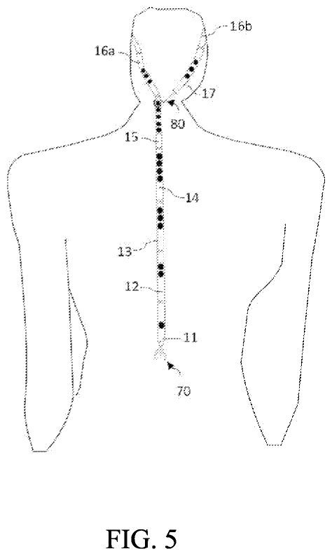

In use, as FIG. 5 shows, the user can conveniently wear the wearable wellness device 100 by putting the wearable wellness device 100 around the user's head, wrapping the desired sections 11,12,13,14,15,16a,16b,17 (e.g., two sixth 16a,16b and the seventh sections 17) around the head. The user can make a loop by using the clasp provided at the end of the last section 17 (which can be the sixth section) and adjusting the size of the loop so that the wearable wellness device 100 can be worn on the user's head, aligning the sections 11,12,13,14,15,16a,16b,17 of the present invention substantially with the center of the user's back.

Although the invention has been explained in relation to its preferred embodiment, it is to be understood that many other possible modifications and variations can be made without departing from the spirit and scope of the invention.

What is claimed is:

1. A wearable wellness device comprising:
a plurality of sections including:
a bracket secured in each of the plurality of sections;
two side members secured in each of the plurality of sections;
a first line member connected to the side members;
a second line member connected to the side members; and
a plurality of stones attached to the bracket; wherein the plurality of sections are connected by the first line member and the second line member; wherein the plurality of sections comprising
a first section having one or more add-ons attached on one end;
a second section, the second section being connected to the first section;
a third section, the third section being connected to the second section;
a fourth section, the fourth section being connected to the third section;
a fifth section, the fifth section being connected to the fourth section;
a first sixth section, the sixth section being connected to the fifth section;
a second sixth section, the sixth section being connected to the first sixth section; and
a seventh section having a chain with a clasp, the seventh section being connected to the second sixth section.

2. The wearable wellness device of claim 1, wherein
the first section includes at least one black tourmaline stone;
the second section includes at least two carnelian stones;
the third section includes at least one citrine and one tiger's eye stones;
the fourth section includes at least four malachite stones or four rose quartz stones;
the fifth section includes at least five blue lace agate stones;
the first sixth section includes at least three selenite tones;
the second sixth section includes at least three selenite stones; and
the seventh section include at least seven Iolite stones.
